(19) United States
(12) Patent Application Publication
(10) Pub. No.: US 2026/0312462 A1
(43) Pub. Date: Oct. 8, 2026

(54) ELECTROMECHANICAL TRANSDUCTION FOR ENERGY STORAGE COMPLIANT MECHANISMS

(71) Applicant: Brigham Young University, Provo, UT (US)

(72) Inventors: Larry L. HOWELL, OREM, UT (US); Jared C. ERICKSON, PROVO, UT (US); Brian D. JENSEN, OREM, UT (US)

(73) Assignee: Brigham Young University, Provo, UT (US)

(21) Appl. No.: 19/569,907

(22) Filed: May 21, 2026

Related U.S. Application Data
(60) Provisional application No. 63/773,136, filed on Mar. 17, 2025.

(51) Int. Cl. H02K 7/18; H02K 7/116; H02K 23/52; H02K 23/68

(52) U.S. Cl. CPC H02K 7/1869; H02K 7/116; H02K 23/52; H02K 23/68; H02K 2213/03

(57) ABSTRACT

A compliant mechanism-driven mechanical battery system and method for electromechanical energy transduction. The system includes a compliant mechanism configured to store strain energy through elastic deformation of one or more flexible members, a rack-and-pinion assembly mechanically coupled to the compliant mechanism to convert linear displacement to rotational displacement, a gear train coupled to the rack-and-pinion assembly having a gear ratio, rotational inertia, and mechanical efficiency, and a brushed DC motor-generator coupled to the gear train. The motor-generator operates as a motor during a charging mode to convert electrical input energy into mechanical strain energy stored in the compliant mechanism, and as a generator during an energy recovery mode to convert stored strain energy into electrical output energy delivered to a load resistance. A closed-form analytical expression for steady-state energy recovery efficiency is provided, along with an optimal load resistance formula that maximizes energy recovery and is independent of the spring constant of the compliant mechanism. The system is capable of theoretically infinite charge-recovery cycles, rapid charge and discharge rates, and operation without hazardous chemical materials.

### PRIORITY CLAIM

This application claims the benefit of and priority to U.S. Provisional Patent Application 66/773,136 filed on Mar. 17, 2025.

### BACKGROUND

Flexure mechanisms, which achieve motion and force transmission through the elastic deformation of flexible members rather than rigid linkages and joints, have a long history rooted in both natural and human-engineered systems. One of the earliest examples dates back several millennia to the bow and arrow, where the flexible limbs store and release strain energy to propel the projectile. Ancient catapults similarly utilized the elasticity of materials like wood and sinew for energy storage and transfer. During the Renaissance, Leonardo da Vinci's sketches incorporated flexible elements in various devices, demonstrating early recognition of flexibility for achieving complex motions.

In the modern era, flexure mechanisms gained renewed attention with the Wright brothers' use of wing warping in their 1903 aircraft, enabling controlled flight through elastic deformation of the wings. Systematic academic study began in the late 1980s at Purdue University under Professor Ashok Midha, often regarded as the “Father of Compliant Mechanisms,” who pioneered the integration of flexible segments into mechanism design (commonly referred to as compliant or flexure-based mechanisms). By the 1990s, advances in continuum topology optimization and materials science propelled the field forward, allowing for the design of flexure structures with predictable deformation behaviors. Today, flexure mechanisms are widely applied in aerospace, robotics, micro-electromechanical systems (MEMS), biomedical devices, and precision instrumentation, offering advantages such as reduced part count, elimination of friction and wear, increased reliability, and inherent energy storage via strain energy in deflected elements.

Parallel to the evolution of flexure mechanisms, energy storage technologies have progressed from rudimentary methods to sophisticated systems essential for modern renewable energy integration. Ancient civilizations employed thermal storage using hot stones heated by fire and insulated in pits, or mechanical storage via reservoirs for hydropower. The 19th century marked significant advancements: pumped hydroelectric storage emerged in Italy and Switzerland around the 1890s, while Gaston Plante invented the rechargeable lead-acid battery in 1859, building on Alessandro Volta's 1800 voltaic pile and Benjamin Franklin's 1749 coining of the term “battery.” The 20th century saw diversification, including flywheels for mechanical storage and molten salt thermal systems demonstrated in the 1996 Solar Two project.

The late 20th and early 21st centuries witnessed explosive growth driven by the need for grid stability amid rising renewable sources like solar and wind. Lithium-ion batteries, conceptualized in the 1970s and commercialized in the 1990s, now dominate electrochemical storage due to high energy density, though alternatives like sodium-ion batteries offer cost and safety benefits. By the 2010s, global non-pumped hydro storage capacity surged, with battery energy storage systems (BESS) accounting for much of the growth. Current technologies encompass mechanical (e.g., compressed air, flywheels), thermal (e.g., phase-change materials), chemical (e.g., hydrogen), and electromagnetic (e.g., supercapacitors) methods, addressing short- and long-duration needs.

Despite these advancements, traditional energy storage systems often suffer from limitations such as material fatigue, efficiency losses, high costs, and scalability challenges. Flexure mechanisms, with their ability to store energy as elastic strain and release it efficiently through controlled deformation, present an underexplored opportunity for integration into energy storage. Recent research has applied flexure-based designs in vibration energy harvesting, constant-force mechanisms, and multi-stable systems that enhance bandwidth and power output through nonlinear deformation. For instance, flexure structures combined with piezoelectric or triboelectric transducers have shown promise in wearable and micro-scale applications, while larger-scale implementations could leverage topology optimization for high-capacity storage with minimal moving parts.

However, existing approaches have not fully capitalized on the potential of flexure mechanisms for large-scale, durable energy storage, where elastic deformation could mitigate wear, reduce complexity, and improve response times. There remains a need for innovative systems that harness flexure mechanisms to achieve efficient, high-capacity energy storage while addressing the intermittency of renewables and demands for sustainable power solutions.

### SUMMARY OF THE DISCLOSURE

Disclosed herein is an electromechanical transduction for energy storage compliant mechanisms

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. The advantages of the disclosure will become better understood with regard to the following description and accompanying drawings where:

FIG. 1 illustrates a potential compliant mechanism-driven mechanical battery system.

FIG. 2 illustrates a detailed schematic of a compliant mechanism-driven mechanical battery system.

FIG. 3 illustrates a graph showing speed over time for an example of a compliant-mechanism-driven mechanical battery during the charging and recovery phases.

FIG. 4 illustrates a graph of voltage and current over time for an example of a compliant mechanism-driven mechanical battery system during the charging and recovery phases.

FIG. 5 illustrates a graph showing transient efficiencies during charging, energy recovery, and their combined round-trip efficiency over time for a compliant mechanism-driven mechanical battery system.

FIG. 6 illustrates a graph showing energy recovery efficiency as a function of load resistance for the example compliant mechanism-driven mechanical battery system, illustrating the optimal load resistance predicted by the analytical formula.

FIG. 7 illustrates a pole-zero plot showing the system poles of the example compliant mechanism-driven mechanical battery system in the complex plane.

### DETAILED DESCRIPTION

In the following description of the disclosure, reference is made to the accompanying drawings, which form a part hereof, and in which are shown by way of illustration-specific implementations in which the disclosure may be practiced. It is understood that other implementations may be utilized, and structural changes may be made without departing from the scope of the disclosure.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or similar parts. It is further noted that elements disclosed with respect to particular embodiments are not restricted to only those embodiments in which they are described. For example, an element described in reference to one embodiment or figure may be alternatively included in another embodiment or figure, regardless of whether or not those elements are shown or described in another embodiment or figure. In other words, elements in the figures may be interchangeable between various embodiments disclosed herein, whether shown or not.

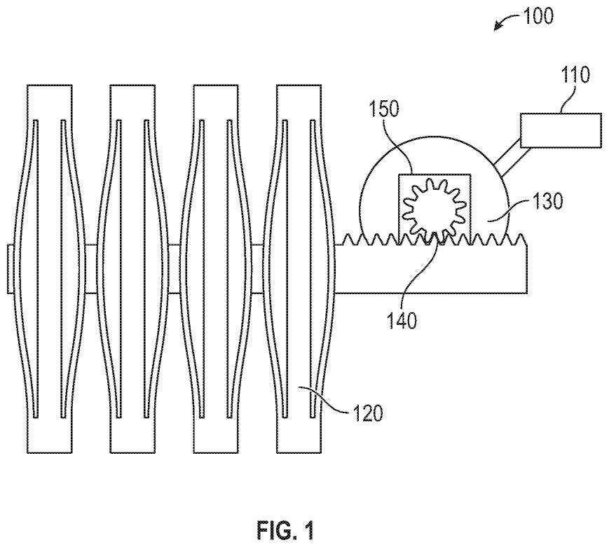

FIG. 1 illustrates a potential compliant mechanism-driven mechanical battery system 100. Compliant mechanism-driven mechanical battery system 100 may include: a compliant mechanism 120 having linear motion and configured to store strain energy through elastic deformation; a rack-and-pinion assembly 140 mechanically coupled to compliant mechanism 120; gear train 150 coupled to the rack-and-pinion assembly 140; and motor-generator 130 coupled to gear train 150, wherein the motor-generator may be a brushed DC motor-generator that may be configured to operate as a motor during charging to store electrical energy as strain energy in the compliant mechanism, and as a generator during energy recovery to convert stored strain energy into electrical energy.

Compliant mechanism 120 may store strain energy through the deformation of elastic members. Compliant mechanism 120 may offer several potential advantages for energy storage systems. First, it can be designed to have theoretically infinite fatigue life, meaning it could enable battery designs that allow nearly infinite recharge cycles. Second, because it may store energy in material deformation, compliant mechanisms may be made from a diverse range of materials. Its flexibility enables cost-effective. Third, using compliant mechanism 120 in a mechanical battery would have environmental benefits. The use of harmful chemicals would be avoided both during the manufacturing and disposal of such a battery. Lastly, it can be charged quickly and release energy quickly because it is not constrained by chemical processes.

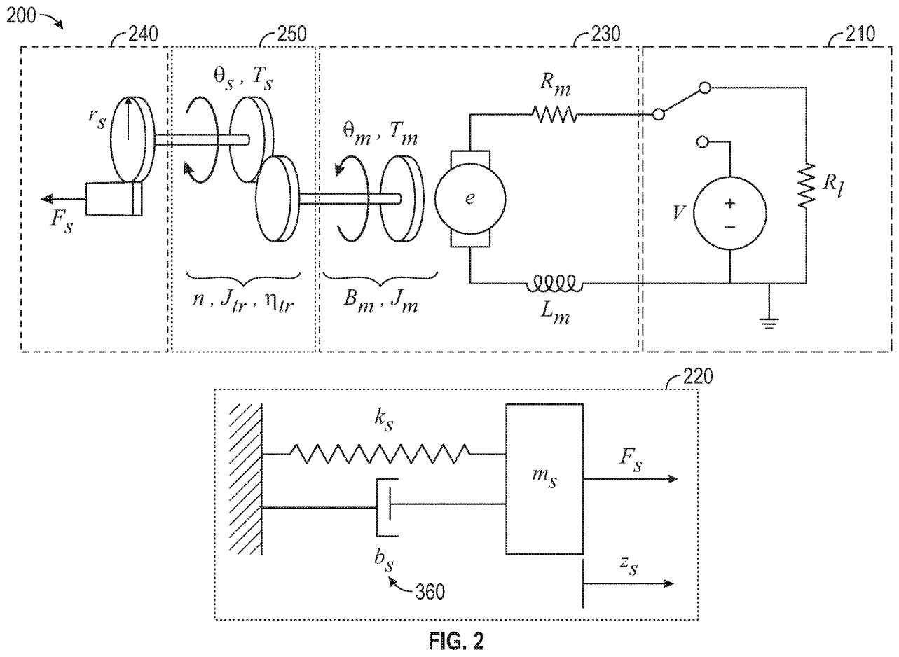

FIG. 2 illustrates a detailed schematic of a compliant mechanism-driven mechanical battery system 200. Compliant mechanism-driven mechanical battery system 100 may include: a compliant mechanism 220 having linear motion and configured to store strain energy through elastic deformation; a rack-and-pinion assembly 240 mechanically coupled to compliant mechanism 220; gear train 250 coupled to the rack-and-pinion assembly 240; and motor-generator 230 coupled to gear train 250, wherein the motor-generator may be a brushed DC motor-generator that may be configured to operate as a motor during charging to store electrical energy as strain energy in the compliant mechanism, and as a generator during energy recovery to convert stored strain energy into electrical energy.

Compliant mechanism 220 may store strain energy through the deformation of elastic members. Compliant mechanism 220 may offer several potential advantages for energy storage systems. First, it can be designed to have theoretically infinite fatigue life, meaning it could enable battery designs that allow nearly infinite recharge cycles. Second, because it may store energy in material deformation, compliant mechanisms may be made from a diverse range of materials. Its flexibility enables cost-effective. Third, using compliant mechanism 220 in a mechanical battery would have environmental benefits. The use of harmful chemicals would be avoided both during the manufacturing and disposal of such a battery. Lastly, it can be charged quickly and release energy quickly because it is not constrained by chemical processes.

Compliant mechanism 220 may be characterized by an effective mass “m”, a linear spring constant Kₛ, and a viscous damping coefficient bₛ. Compliant mechanism 220 may be constrained to linear motion along a single axis defined by position coordinate zs measured relative to the unstretched state of the elastic members. In the preferred embodiment, the compliant mechanism is designed with geometries and material selections that maximize energy density and provide a theoretically infinite fatigue life through elastic deformation rather than sliding contact.

Rack-and-pinion assembly 240 connects the linear displacement zs of the compliant mechanism to the angular displacement θs of the gear train output shaft, with pinion radius rs, such that zs=rsθs and the transmitted force Fs=rs Ts, where Ts is the torque at the gear train output shaft.

Gear train 250 has gear ratio n, rotational inertia Jtr, and mechanical efficiency ηtr. During charging, the gear train transmits torque from the motor-generator to the rack-and-pinion with the relationship Tm=(1/(ηtr·n))·Ts+Jtr θ\dot{m}, where Tm is the motor output torque and θm is the motor shaft angle. During energy recovery, the torque relationship is Tm=(ηtr/n) Ts+Jtr θ\dot{m}, reflecting the directional dependence of gear train friction losses.

Motor-generator 230 has rotor moment of inertia Jm, viscous damping coefficient Bm, back-EMF speed constant Ke, torque constant Kt, armature inductance Lm, and internal resistance Rm. The motor shaft angle θm=nθs. The damping coefficient is determined by the no-load operating parameters as Bm=Kt·Inl/ωnl, where Inl is the no-load current and ωnl is the no-load speed.

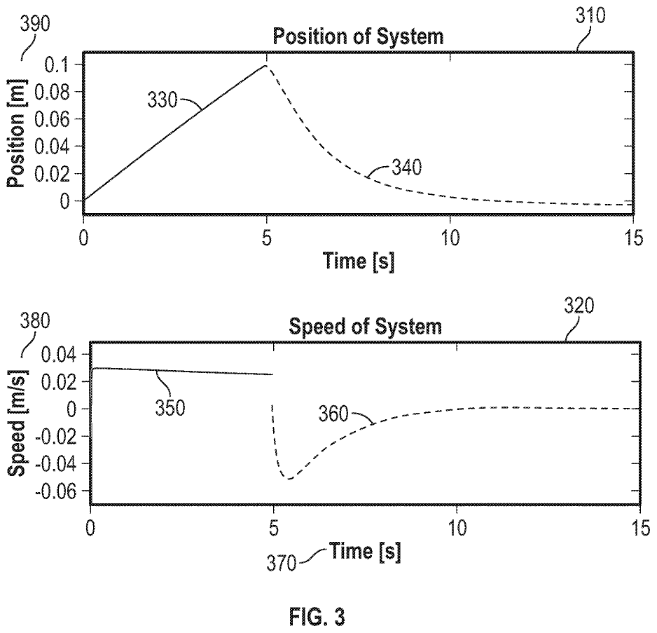

FIG. 3 illustrates a graphical representation of position and speed response for an example of a compliant-mechanism-driven mechanical battery during the charging and recovery phases. Graph 310 represents the position 390 along the y axis and time along the x axis. Graph 310 includes charging position 310 and recovery position 340. Graph 320 represents the speed response during charging 350 and recovery 360. Along the y-axis is the speed [m/s] and time [s] is measured along the x axis During charging, an input voltage V is applied across the motor-generator terminals. The governing equations of the coupled electromechanical system during charging are:
(a) Mechanical equation of the compliant mechanism. Fs=ms·\ddot{z}s+bs·żs+ks·zs
(b) Electrical equation of the motor: Lm·dl/dt+Rm·I=V−Ke·\acute{θ}m (c) Rotational equation of the motor: Jm·θ\dot{m}+Bm·θ\dot{m}+Tm=Kt·I

These equations are combined and rearranged into state-space form using the state variables {I, żs, zs}. The state-space equations during charging are:

$$dI / dt = ( 1 / Lm ) \cdot [ V - ( nKe \dot{z} s / rs ) - Rm \cdot I ]$$

$$d \dot{z} s / dt = - 1 / [ {n}^{2} η tr ( Jm + Jtr ) + {rs}^{2} \cdot m ] \cdot [ ( {n}^{2} η tr Bm + {rs}^{2} bs ) \dot{z} s + {rs}^{2} ks zs - Ke rs n η tr I$$

$$dzs / dt = \dot{z} s$$

During energy recovery, no voltage source is applied. Instead, a load resistance Rl is connected across the motor-generator terminals to dissipate recovered electrical energy. The governing equations during energy recovery differ from charging in two respects: the voltage source V is removed, and the load resistance Rl appears in series with the motor internal resistance. The state-space equations during energy recovery are:

$$dI / dt = ( 1 / Lm ) \cdot [ - ( nKe \dot{z} s / rs ) - ( Rm + Rl ) \cdot I ]$$

$$d \dot{z} s / dt = - 1 / [ {n}^{2} ( Jm + Jtr ) + η tr {rs}^{2} m ] \cdot [ ( {n}^{2} Bm + η tr {rs}^{2} bs ) \dot{z} s + η tr {rs}^{2} ks zs - Ke rs n I ]$$

$$dzs / dt = \dot{z} s$$

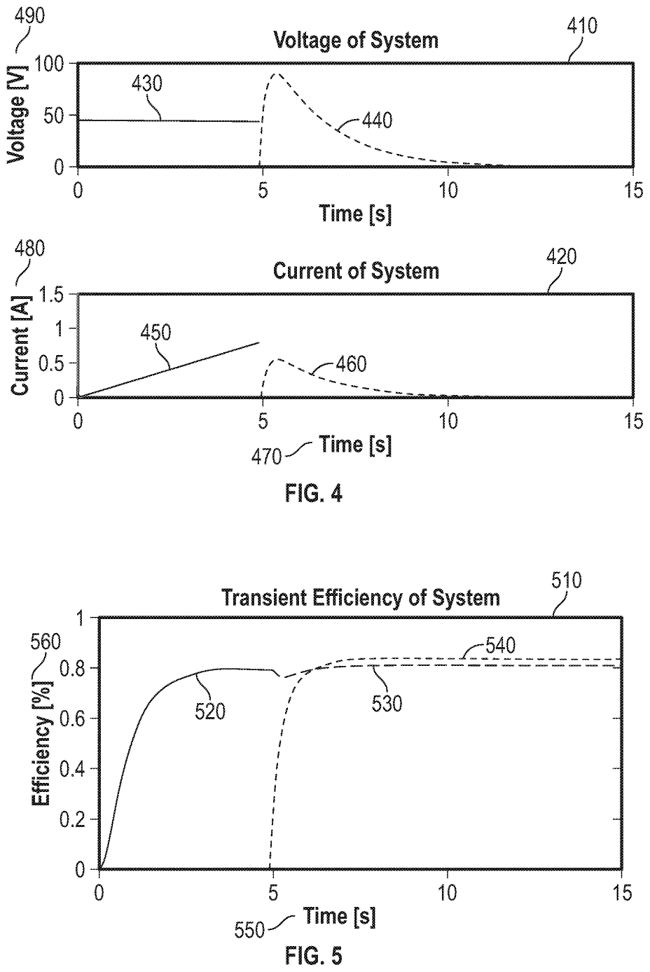

FIG. 4 illustrates graphs 410 and 420 of voltage and current over time for an example of a compliant-mechanism-driven mechanical battery system during the charging and recovery phases. Graph 410 includes charging voltage 430 and recovery voltage 440. Voltage [V] 490 is measured along the y-axis, and time [s] 470 is measured along the x-axis. Graph 420 includes charging current 450 and recovery current 460. Current [A] 480 is measured along the y-axis, and time [s] 470 is measured along the x-axis.

System 100 is governed during charging by state-space equations:
dI/dt=(1/Lm)[V−(nKeżs/rs)−Rm I]; dżs/dt=−1/[n²ηtr(Jm+Jtr)+rs² m]·[(n²ηtr Bm+rs² bs)żs+rs² ks zs−Ke rs n ηtr I]; and dzs/dt=żs; where I is armature current, Lm is motor inductance, V is applied voltage, Ke is the speed constant, n is gear ratio, rs is pinion radius, Rm is motor internal resistance, ηtr is gear train efficiency, Jm and Jtr are rotor and gear train inertias, Bm is motor damping, bs is spring damping, ks is spring constant, and zs is spring position.

FIG. 5 illustrates a graph showing transient efficiencies during charging, energy recovery, and their combined round-trip efficiency over time for a compliant mechanism-driven mechanical battery system. The charging efficiency at time t is defined as the ratio of strain energy stored in the compliant mechanism to cumulative electrical input energy:

$$η charging = [ ( 1 / 2 ) ks ( z {0}^{2} - {zs}^{2} ) ] / [ \int IV dt ] .$$

The energy recovery efficiency at time t is defined as the ratio of cumulative electrical energy dissipated in the load resistance to the strain energy initially stored:

$$η recovery = [ \int {I}^{2} Rl dt ] / [ ( 1 / 2 ) ks ( z {0}^{2} - {zs}^{2} ) ]$$

In the steady-state limit as zs→0, żs→0, and t→∞, the steady-state energy recovery efficiency reduces to the closed-form expression:

$$η recovery = [ Rl {n}^{2} {Ke}^{2} η tr ] / \{ {( Rm + Rl )}^{2} \cdot [ ( {n}^{2} Bm + η tr {rs}^{2} bs ) ] + ( Rm + Rl ) ( {n}^{2} {Ke}^{2} ) \}$$

This result demonstrates that the steady-state recovery efficiency is independent of the spring constant ks of the compliant mechanism. The spring constant affects only the system dynamics, not the ultimate efficiency of energy recovery. Parameters that increase efficiency include: increasing the gear ratio n, increasing the motor torque constant Ke, increasing the gear train efficiency ηtr, and decreasing the motor internal resistance Rm, motor damping Bm, pinion radius rs, and spring damping coefficient bs.

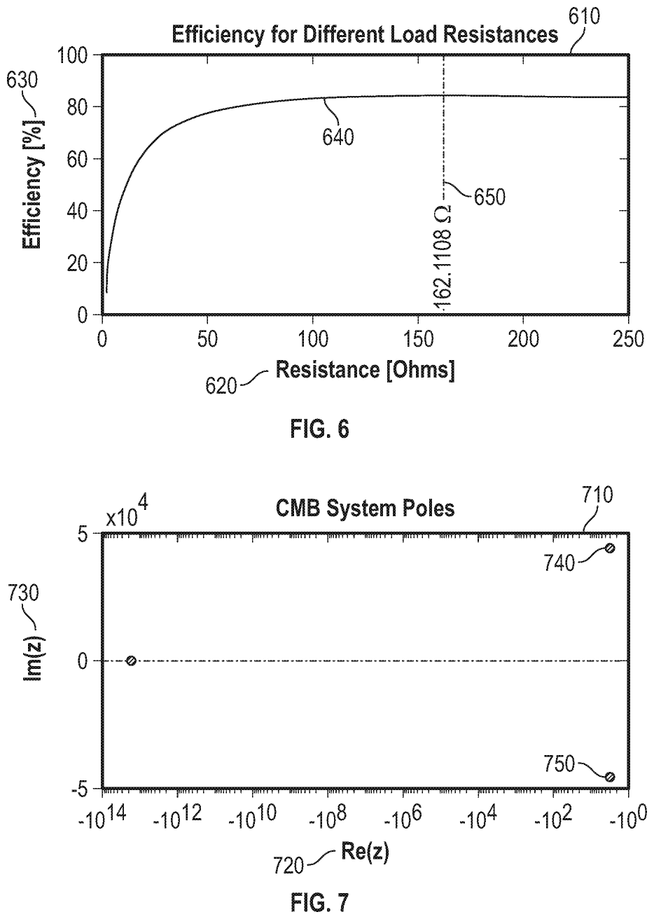

FIG. 6 illustrates a graph showing energy recovery efficiency as a function of load resistance for the example compliant mechanism-driven mechanical battery system, illustrating the optimal load resistance predicted by the analytical formula.

The charging efficiency at time t is defined as the ratio of strain energy stored in the compliant mechanism to cumulative electrical input energy:

$$η charging = [ ( 1 / 2 ) ks ( z {0}^{2} - {zs}^{2} ) ] / [ \int IV dt ]$$

The energy recovery efficiency at time t is defined as the ratio of cumulative electrical energy dissipated in the load resistance to the strain energy initially stored:

$$η recovery = [ \int {I}^{2} Rl dt ] / [ ( 1 / 2 ) ks ( z {0}^{2} - {zs}^{2} ) ]$$

In the steady-state limit as zs→0, żs→0, and t→∞, the steady-state energy recovery efficiency reduces to the closed-form expression:

$$η recovery = [ Rl {n}^{2} {Ke}^{2} η tr ] / \{ {( Rm + Rl )}^{2} \cdot [ ( {n}^{2} Bm + η tr {rs}^{2} bs ) ] + ( Rm + Rl ) ( {n}^{2} {Ke}^{2} ) \}$$

This result demonstrates that the steady-state recovery efficiency is independent of the spring constant ks of the compliant mechanism. The spring constant affects only the system dynamics, not the ultimate efficiency of energy recovery. Parameters that increase efficiency include increasing the gear ratio n, increasing the motor torque constant Ke, increasing the gear train efficiency ηtr, and decreasing the motor internal resistance Rm, motor damping Bm, pinion radius rs, and spring damping coefficient bs.

FIG. 7 illustrates plot 700 of the system poles 740 and 750 of a compliant mechanism-driven mechanical battery system 100 in the complex plane. To characterize system dynamics during energy recovery, the following constants are defined: C4=n²(Jm+Jtr)+ηtr rs² ms; C5=n² Bm+ηtr rs² bs; C6=ηtr rs² ks; C7=Ke rs n; C8=Lm rs; C9=nKe; C10=rs(Rs+Rm). The state matrix A of system 100 during energy recovery is a 3×3 matrix from which the system poles 740 and 750 are computed as eigenvalues. Poles 740 and 750 govern whether the system 100 response is overdamped (real poles), critically damped, or underdamped (complex conjugate poles). An overdamped or critically damped design is preferred to minimize direction reversals of the compliant mechanism 120, thereby reducing gear train 150 backlash losses and motor 130 brush wear.

For real poles, the velocity of the compliant mechanism takes a biexponential form. For complex conjugate poles, the velocity takes a decaying sinusoidal form. In both cases, integration of the squared velocity over the full recovery period yields the same closed-form expression for steady-state recovery efficiency given above.

An example embodiment is defined by the following parameters: input voltage V=45 V; motor internal resistance Rm=10Ω; load resistance Rl=162Ω; motor rotational inertia Jm=50×10⁻⁷ kg·m²; motor inductance Lm=0.1×10⁻¹⁰⁰ H; torque constant Ke=0.1 N m/A; no-load speed ωnl=523.6 rad/s; no-load current Inl=0.02 A; motor damping Bm=3.28×10⁻⁶ N m·s/rad; gear ratio n=50; pinion radius rs=0.0025 m; gearbox rotational inertia Jtr=5×10⁻⁶ kg·m²; gearbox efficiency ηtr=0.95; effective mass ms=0.1 kg; spring damping bs=0.001 N·s/m; spring constant ks=1.5×10⁴ N/m.

With these parameters, the system achieves a charging efficiency of 79.0%, an energy recovery efficiency of 84.0%, and an overall round-trip efficiency of 81.2% over a 15-second charge-and-recovery cycle. The optimal load resistance computed from the analytical formula is 162.11Ω, in agreement with the numerical simulation results. On plot 700, pole 740 is located at −13.10±4.45×10⁴ i, and Pole 750 is located at −1.72×10¹³+9.98×10⁻⁵ i, indicating a stable, overdamped mechanical response.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A compliant mechanism-driven mechanical battery system, comprising:
a compliant mechanism storing strain energy through elastic deformation of one or more flexible members, the compliant mechanism constrained to linear motion along a single displacement axis;
a rack-and-pinion assembly mechanically coupled to the compliant mechanism, the rack-and-pinion assembly converting linear displacement of the compliant mechanism to rotational displacement of a pinion shaft;
a gear train coupled to the rack-and-pinion assembly, the gear train having a gear ratio, a rotational inertia, and a mechanical efficiency; and
a motor-generator coupled to the gear train, the motor-generator configured to operate as a motor during a charging mode to drive the compliant mechanism from an undeflected state to a deflected state thereby converting electrical input energy into mechanical strain energy stored in the compliant mechanism, and configured to operate as a generator during an energy recovery mode to convert stored strain energy into electrical output energy.

2. The system of claim 1, wherein the motor-generator is a brushed DC motor-generator.

3. The system of claim 1, wherein the rack-and-pinion assembly has a pinion radius rs such that the linear displacement zs of the compliant mechanism and the angular displacement θs of the gear train output shaft satisfy the kinematic relationship zs=rs·θs, and the transmitted force Fs and gear train output torque Ts satisfy Fs=rs·Ts.

4. The system of claim 2, wherein the brushed DC motor-generator has a viscous damping coefficient Bm determined from no-load operating parameters according to Bm=Kt·Inl/ωnl, where Kt is the motor torque constant, Inl is the no-load armature current, and ωnl is the no-load angular speed.

5. The system of claim 1, wherein the gear train transmits torque from the motor-generator to the rack-and-pinion assembly during the charging mode according to
Tm=(1/(ηtr·n))·Ts+Jtr·θ\dot{m}, and transmits torque during the energy recovery mode according to Tm=(ηtr/n)·Ts+Jtr·θ\dot{m}, where Tm is the motor output torque, n is the gear ratio, ηtr is the mechanical efficiency, Ts is the torque at the gear train output shaft, Jtr is the gear train rotational inertia, and θ\dot{m} is the motor shaft angular acceleration, the directional asymmetry in these relationships reflecting the effect of gear train friction losses on power flow direction.

6. The system of claim 1, wherein during the charging mode the coupled electromechanical dynamics of the system are governed by the state-space equations:
$$dI / dt = ( 1 / Lm ) [ V - ( n \cdot Ke \cdot \dot{z} s / rs ) - Rm \cdot I ] ;$$
$$d \dot{z} s / dt = - 1 / [ {n}^{2} η tr ( Jm + Jtr ) + {rs}^{2} \cdot m ] \cdot [ ( {n}^{2} η tr \cdot Bm + {rs}^{2} \cdot bs ) \dot{z} s + {rs}^{2} \cdot ks \cdot zs - Ke \cdot rs \cdot n \cdot η tr \cdot I ] ;$$
$$and$$
$$dzs / dt = \dot{z} s ;$$
where I is armature current, Lm is motor inductance, V is applied voltage, Ke is the motor speed constant, n is the gear ratio, rs is pinion radius, Rm is motor internal resistance, ηtr is gear train efficiency, Jm is rotor inertia, Jtr is gear train inertia, m is the effective mass of the compliant mechanism, Bm is motor damping coefficient, bs is the compliant mechanism damping coefficient, ks is the compliant mechanism spring constant, zs is compliant mechanism position, and żs is compliant mechanism velocity.

7. The system of claim 1, wherein during the energy recovery mode, a load resistance Rl is connected across the motor-generator terminals and the system dynamics are governed by the state-space equations:
$$dI / dt = ( 1 / Lm ) [ - ( n \cdot Ke \cdot \dot{z} s / rs ) - ( Rm + Rl ) \cdot I ] ;$$
$$d \dot{z} s / dt = - 1 / [ {n}^{2} ( Jm + Jtr ) + η tr \cdot {rs}^{2} \cdot m ] \cdot [ ( {n}^{2} \cdot Bm + η tr \cdot {rs}^{2} \cdot bs ) \dot{z} s + η tr \cdot {rs}^{2} \cdot ks \cdot zs - Ke \cdot rs \cdot n \cdot I ] ;$$
$$and$$
$$dzs / dt = \dot{z} s ;$$
where Rl is the load resistance connected across the motor-generator terminals during energy recovery, and the remaining variables are as defined in claim 6.

8. The system of claim 7, wherein a steady-state energy recovery efficiency of the system, in the limit as the compliant mechanism position and velocity both approach zero, is given by:
$$η recovery = [ Rl \cdot {n}^{2} \cdot {Ke}^{2} \cdot η tr ] / \{ {( Rm + Rl )}^{2} \cdot ( {n}^{2} \cdot Bm + η tr \cdot {rs}^{2} \cdot bs ) + ( Rm + Rl ) \cdot ( {n}^{2} \cdot {Ke}^{2} ) \} ,$$
wherein the steady-state energy recovery efficiency is independent of the spring constant ks of the compliant mechanism.

9. The system of claim 8, wherein the load resistance Rl is set to an optimal value RL,optimal that maximizes the steady-state energy recovery efficiency, the optimal load resistance being given by:
$$RL , optimal = √ \{ [ {Rm}^{2} ( {n}^{2} \cdot Bm + η tr \cdot {rs}^{2} \cdot bs ) + Rm \cdot {n}^{2} \cdot {Ke}^{2} ] / ( {n}^{2} \cdot Bm + η tr \cdot {rs}^{2} \cdot bs ) \} ,$$
wherein the optimal load resistance is independent of the spring constant ks of the compliant mechanism.

10. The system of claim 8, wherein the steady-state energy recovery efficiency is increased by one or more of: increasing the gear ratio n, increasing the motor speed constant Ke, increasing the gear train mechanical efficiency ηtr, decreasing the motor internal resistance Rm, decreasing the motor damping coefficient Bm, decreasing the pinion radius rs, and decreasing the compliant mechanism damping coefficient bs.

11. The system of claim 7, wherein the gear train, compliant mechanism, and motor-generator are selected such that the eigenvalues of the state matrix governing energy recovery dynamics are real and negative, yielding an overdamped mechanical response that minimizes directional reversals of the compliant mechanism during energy recovery, thereby reducing gear train backlash losses and motor brush wear.

12. The system of claim 1, wherein the one or more flexible members of the compliant mechanism are fabricated from one or more of metallic alloys, carbon nanotube yarn, polymer composites, or other elastic materials selected to maximize energy storage density while maintaining purely elastic deformation throughout all operating cycles.

13. The system of claim 1, wherein the compliant mechanism is designed with geometries and material properties selected to maintain elastic deformation throughout all operating cycles, providing a theoretically infinite fatigue life that enables a substantially unlimited number of charge-and-recovery cycles without material failure.

14. The system of claim 1, wherein the system stores and releases energy exclusively through mechanical strain energy in the compliant mechanism and electromagnetic energy conversion in the motor-generator, without use of electrochemical reactions or hazardous chemical materials, such that the system is manufacturable and disposable without chemical waste treatment.

15. The system of claim 1, wherein a charging efficiency of the system at time t during the charging mode is defined as a ratio of instantaneous strain energy stored in the compliant mechanism to cumulative electrical input energy, according to:
$$η charging = [ ( 1 / 2 ) \cdot ks \cdot ( z {0}^{2} - {zs}^{2} ) ] / [ \int I \cdot V dt ] ,$$
where z0 is the initial stretched position of the compliant mechanism, zs is the current position, ks is the spring constant, I is armature current, and V is applied voltage.

16. The system of claim 15, wherein a round-trip efficiency of the system over a complete charge-and-recovery cycle is defined as a product of the charging efficiency and an energy recovery efficiency, the energy recovery efficiency being defined as a ratio of cumulative electrical energy dissipated in the load resistance during energy recovery to the strain energy initially stored in the compliant mechanism at the commencement of energy recovery.

17. The system of claim 7, wherein when the eigenvalues of the energy recovery state matrix are real and negative the velocity of the compliant mechanism during energy recovery takes a biexponential form, and when the eigenvalues are complex conjugates with negative real parts the velocity takes a decaying sinusoidal form, both forms yielding the same closed-form steady-state energy recovery efficiency.

18. A compliant mechanism-driven mechanical battery system, comprising:
a compliant mechanism having an effective mass ms, a linear spring constant ks, and a viscous damping coefficient bs, the compliant mechanism configured to store mechanical strain energy through elastic deformation of one or more flexible members along a single linear axis;
a rack-and-pinion assembly having a pinion radius rs, the rack-and-pinion assembly coupling linear displacement zs of the compliant mechanism to angular displacement θs of a rotary drivetrain output shaft such that zs=rs·θs;
a gear train having a gear ratio n, a rotational inertia Jtr, and a mechanical efficiency ηtr; and
a brushed DC motor-generator having a rotor moment of inertia Jm, a viscous damping coefficient Bm, a back-EMF speed constant Ke, a torque constant Kt, an armature inductance Lm, and an internal resistance Rm, the brushed DC motor-generator coupled to the gear train and configured to operate as a motor during a charging mode and as a generator during an energy recovery mode;
wherein a load resistance Rl is connectable across terminals of the brushed DC motor-generator during the energy recovery mode to receive electrical output energy generated from stored strain energy of the compliant mechanism.

19. The system of claim 18, wherein the load resistance Rl is selected to equal an optimal load resistance RL,optimal=√{[Rm²(n²·Bm+ηtr·rs²·bs)+Rm·n²·Ke²]/(n²·Bm+ηtr·rs²·bs)} to maximize steady-state energy recovery efficiency, the optimal load resistance being independent of the spring constant ks of the compliant mechanism.

20. The system of claim 18, wherein system dynamics during the energy recovery mode are characterized by a 3×3 state matrix defined by constants C4=n²(Jm+Jtr)+ηtr·rs²·ms, C5=n²·Bm+ηtr·rs²·bs, C6=ηtr·rs²·ks, C7=Ke·rs·n, C8=Lm·rs, C9=n·Ke, and C10=rs·(Rl+Rm), wherein eigenvalues of the state matrix are selected to be real and negative by appropriate choice of gear ratio n, pinion radius rs, gear train efficiency ηtr, and motor-generator parameters, such that the compliant mechanism velocity decays monotonically during energy recovery without directional reversals, thereby minimizing backlash losses in the gear train and brush wear in the motor-generator.
